(19) United States
(12) Patent Application Publication
(10) Pub. No.: US 2026/0129718 A1
(43) Pub. Date: May 7, 2026

(54) CONNECTING DISPARATE COMMUNICATION SYSTEMS IN RESPONSE TO EMERGENCY EVENT

(71) Applicant: Intrado Life & Safety, Inc., Longmont, CO (US)

(72) Inventor: Robert E. Leetun, Longmont, CO (US)

(21) Appl. No.: 18/936,240

(22) Filed: Nov. 4, 2024

(51) Int. Cl. H04W 76/50; H04W 24/08; H04W 76/45

(52) U.S. Cl. CPC H04W 76/50; H04W 24/08; H04W 76/45

(57) ABSTRACT

Particular example embodiments described herein can provide for a system, an apparatus, and a method for identifying an emergency event is occurring, determining two or more emergency responders needed to respond to the emergency event, where the two or more emergency responders use disparate communication systems, and automatically creating a virtual talk group with a single communication channel to facilitate communications between the between the two or more emergency responders that use disparate communication systems.

### TECHNICAL FIELD

This disclosure relates in general to the field of computing and/or networking and, more particularly, to a system, an apparatus, and a method to enable connecting disparate communication systems in response to an emergency event.

### BACKGROUND

A public-safety answering point (PSAP), sometimes called a public-safety access point, is a call center where emergency/non-emergency calls (like police, fire brigade, ambulance) are received and handled. The PSAP is a call center in almost all the countries, including Canada and the United States, where a trained PSAP operator is typically responsible for answering calls to an emergency telephone number for police, firefighting, and ambulance services.

During an emergency event, a PSAP will receive a call or text about the emergency event. Based on the type of emergency event, a PSAP operator will dispatch one or more emergency responders to manage and mitigate the emergency event. Typically, each of the emergency responders communicate using a communication system that is unique to each specific emergency responder.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIGS. 1A and 1B are simplified block diagrams of a system to enable connecting disparate communication systems in response to an emergency event, in accordance with an embodiment of the present disclosure;

FIGS. 2A and 2B are simplified block diagrams of a system to enable connecting disparate communication systems in response to an emergency event, in accordance with an embodiment of the present disclosure;

FIG. 3 is simplified block diagram of a system to enable connecting disparate communication systems in response to an emergency event, in accordance with an embodiment of the present disclosure;

FIG. 4 is a simplified block diagram illustrating example details of an emergency event detection mechanism to help enable connecting disparate communication systems in response to an emergency event, in accordance with an embodiment of the present disclosure;

FIG. 5 is a simplified block diagram illustrating example details of an emergency event detection mechanism to help enable connecting disparate communication systems in response to an emergency event, in accordance with an embodiment of the present disclosure;

FIG. 6 is a simplified block diagram illustrating example details of disparate systems connection engine to help enable connecting disparate communication systems in response to an emergency event, in accordance with an embodiment of the present disclosure;

FIG. 7 is a simplified flowchart illustrating potential operations to help enable connecting disparate communication systems in response to an emergency event, in accordance with an embodiment of the present disclosure;

FIG. 8 is a simplified flowchart illustrating potential operations to help enable connecting disparate communication systems in response to an emergency event, in accordance with an embodiment of the present disclosure;

FIG. 9 is a simplified flowchart illustrating potential operations to help enable connecting disparate communication systems in response to an emergency event, in accordance with an embodiment of the present disclosure;

FIG. 10 is a simplified flowchart illustrating potential operations to help enable connecting disparate communication systems in response to an emergency event, in accordance with an embodiment of the present disclosure;

FIG. 11 is a simplified flowchart illustrating potential operations to help enable connecting disparate communication systems in response to an emergency event, in accordance with an embodiment of the present disclosure;

FIG. 12 is a simplified block diagram illustrating example details of an example computer model inference and computer model training to help enable connecting disparate communication systems in response to an emergency event, in accordance with an embodiment of the present disclosure; and

FIG. 13 is a simplified block diagram illustrating examples details of an example neural network architecture to help enable connecting disparate communication systems in response to an emergency event, in accordance with an embodiment of the present disclosure.

The FIGURES of the drawings are not necessarily drawn to scale, as their dimensions can be varied without departing from the scope of the present disclosure.

### DETAILED DESCRIPTION

The following detailed description sets forth examples of apparatuses, methods, and systems relating to enable connecting disparate communication systems in response to an emergency event, in accordance with an embodiment of the present disclosure. Features such as structure(s), function(s), and/or characteristic(s), for example, are described with reference to one embodiment as a matter of convenience; various embodiments may be implemented with any suitable one or more of the described features.

### Overview

A public safety answering point (PSAP) sometimes called a public-safety access point, is a call center where emergency/non-emergency calls (like police, fire brigade, ambulance) are received and handled. During an emergency event, a PSAP will receive a call or text about the emergency event and, based on the type of emergency event, a PSAP operator will dispatch one or more emergency responders to manage and mitigate the emergency event. Typically, each of the emergency responders communicate using a communication system that is unique to each specific emergency responder. Because each of the emergency responders communicate using a communication system that is unique to each specific emergency responder, sometimes it can be difficult to coordinate a response and allow each emergency responder to have the information needed for a response.

In an illustrative example, an emergency situation can occur and an emergency event detection mechanism can be activated. The emergency event detection mechanism can be a user activated detection mechanism, an IoT device and/or a computer model that uses one or more inputs to detect an emergency event, or some other type of emergency event detection mechanism. In response to the emergency event detection mechanism being triggered, a disparate systems connection engine can be configured to automatically (e.g., without direct human intervention) create a single communication channel to allow emergency responders and a local PSAP to communicate with each other in a virtual talk group using a single communication channel. In some examples, one or more safety admin electronic devices that are proximate to the emergency event can be added to the single communication channel to allow users (e.g., a school or building safety officer, manager, principal of a school, etc.) of the safety admin electronic devices to be added to the virtual talk group.

Each of the emergency responders, the PSAP, and the one or more safety admin electronic devices may communicate over one or more handsets, hardline telephones, cell phones, VOIP phones, hand held radios, command center communication systems, private branch exchanges (PBXs), and other disparate communication systems. In some examples, one or more of the emergency responders, the PSAP, and the one or more safety admin electronic devices may communicate using the same type of equipment but over different frequencies. By automatically creating the virtual talk group using a single communication channel, the emergency responders, the PSAP, and the one or more safety admin electronic devices can all communicate with each other over the single communication channel to coordinate a response and allow each emergency responder to have the information needed for a response to the emergency event.

### Example Systems, Apparatuses, and Methods

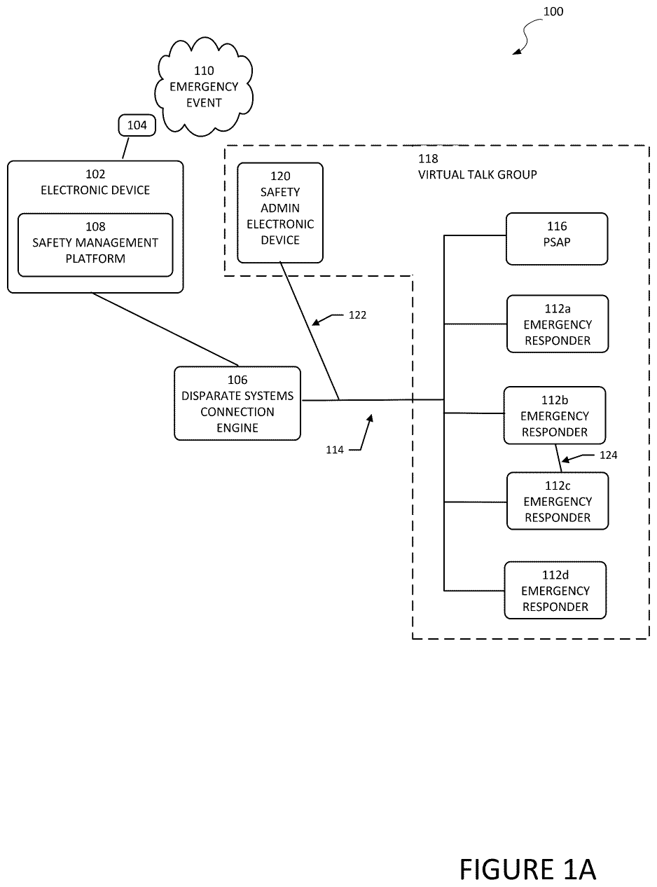

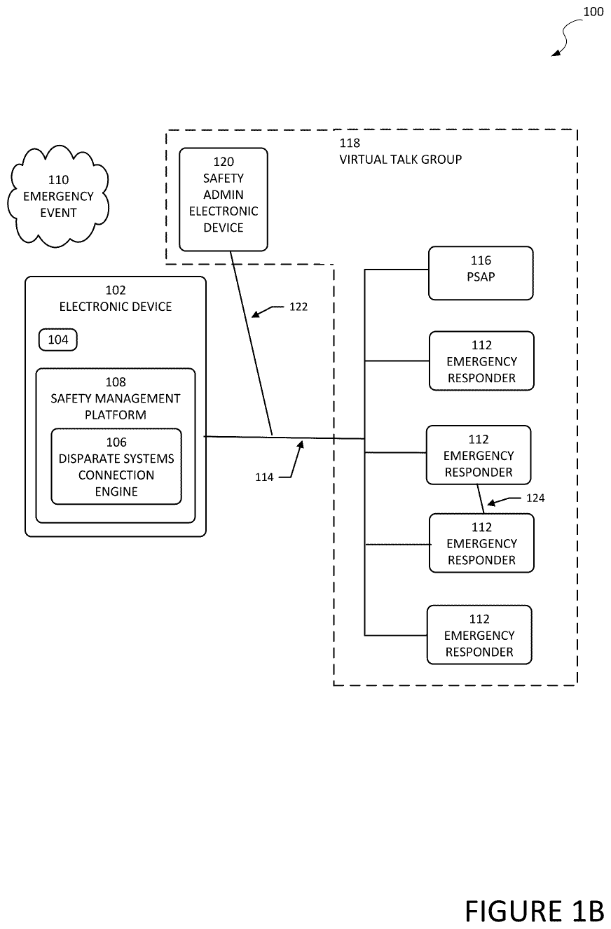

FIGS. 1A and 1B are simplified block diagrams of a particular non-limiting system 100 to enable connecting disparate communication systems in response to an emergency event. The system 100 can include an electronic device 102, an emergency event detection mechanism 104, and a disparate systems connection engine 106. The electronic device 102 can include a safety management platform 108. In some examples, as illustrated in FIG. 1B, the safety management platform 108 includes the disparate systems connection engine 106. The emergency event detection mechanism 104 and/or the safety management platform 108 are configured to contribute to the process of identifying an emergency event 110. The safety management platform 108 can be configured to share data related to the emergency event 110 with emergency responders 112 and a PSAP 116. The disparate systems connection engine 106 is configured to create a single communication channel 114 to allow emergency responders 112 and a local PSAP 116 to communicate with each other in a virtual talk group 118 using the single communication channel 114. In some examples, the safety management platform 108 can be configured to identify a response strategy plan and determine which actions to take and when to perform such actions.

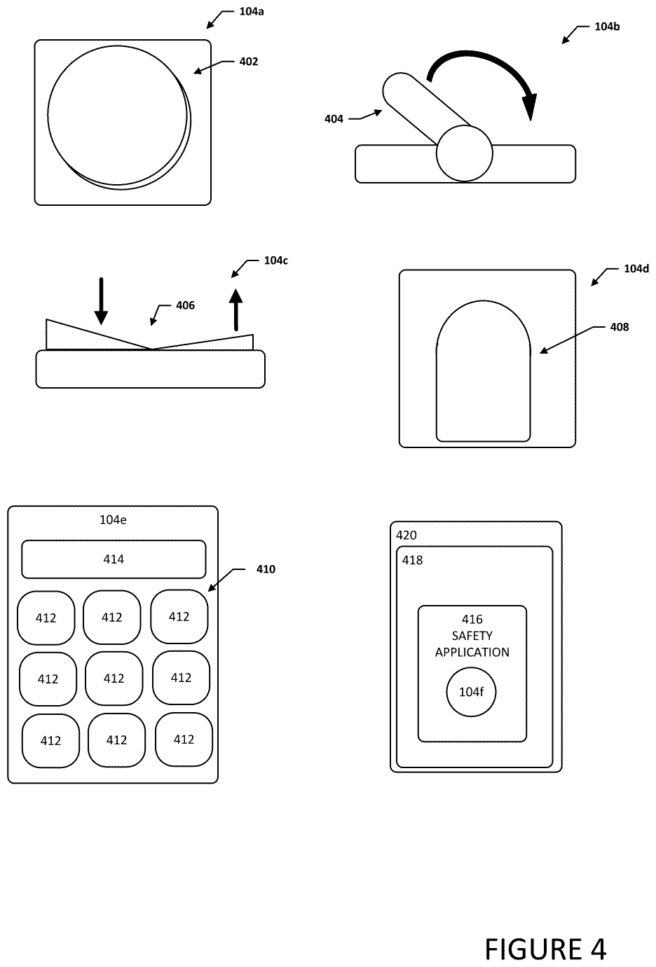

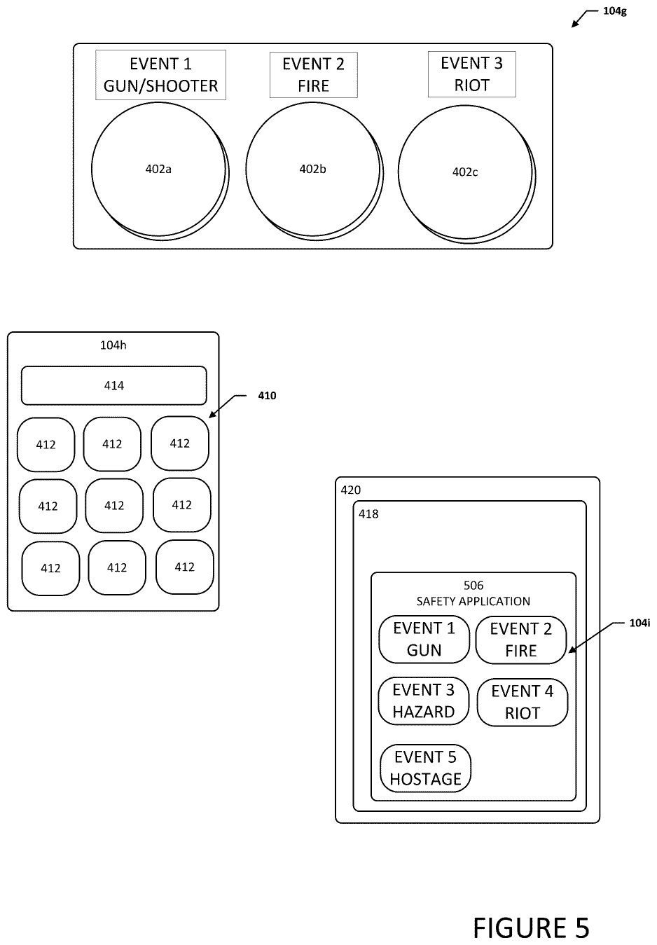

In an example, the emergency event detection mechanism 104 can be a user activated detection mechanism. For example, a user that observes or is made aware of the emergency event 110 can activate the emergency event detection mechanism 104. Various example user activated emergency event detection mechanisms 104 are described in more detail below with reference to FIGS. 4 and 5.

In some examples, the emergency event detection mechanism 104 may be an IoT device and/or a computer model that uses one or more inputs to detect an emergency event. For example, an IoT device may be one or more smoke detectors and when smoke is detected, the emergency event detection mechanism 104 is activated. In another example, the emergency event detection mechanism 104 may a computer model that is trained to recognized various firearms or weapons (e.g., in a video feed from a security camera) and when a firearm or weapon is detected, the emergency event detection mechanism 104 is activated.

In some examples, the emergency event detection mechanism 104 can be used as a general emergency event detection mechanism (one emergency event detection mechanism for an active shooter, fire, chemical spill, etc.). In other examples, the emergency event detection mechanism 104 can be used as a specific emergency event detection mechanism (an active shooter). In yet other examples, as illustrated in FIG. 5, the emergency event detection mechanism 104 can be used as multiple specific emergency event detection mechanisms (e.g., one emergency event detection mechanism for an active shooter, a second emergency event detection mechanism for a fire, a third emergency event detection mechanism for a chemical spill or environmental hazard, etc.)

In response to a detected emergency event 110, the disparate systems connection engine 106 can be configured to automatically create a single communication channel 114 to allow emergency responders 112 and a local PSAP 116 to communicate with each other in a virtual talk group 118 using the single communication channel 114. In some examples, the system 100 can include one or more safety admin electronic devices 120 and the one or more safety admin electronic devices 120 can be automatically added to the virtual talk group 118 and use the single communication channel 114. In some examples, the connection from the safety admin electronic device 120 is a telephone services connection 122 (e.g., landline connection, wireless telephone connection, or some other telephone services connection).

Typically, each of the emergency responders 112 have their own line or channel of communications. For example, the emergency responder 112a may use one or more radio channels for communications while the emergency responders 112b-112d may use different radio channels for communications. Each of the emergency responders 112b-112d, the PSAP 116, and the one or more safety admin electronic devices 120 may communicate over one or more handsets, hardline telephones, cell phones, VOIP phones, hand held radios, command center communication system, private branch exchange (PBX), etc. In some examples, one or more of the emergency responders 112b-112d, the PSAP 116, and the one or more safety admin electronic devices 120 may communicate using the same type of equipment but over different frequencies (e.g., county law enforcement may use hand held radios and communicate using the 800 MHz radio band and while state law enforcement may use the same hand held radios but communicate using the 900 MHz radio band). When responding to an emergency event 110, communication and coordination between the emergency responders 112 and an operator at the PSAP 116 is essential. By creating the single communication channel 114, the disparate systems connection engine 106 can allow emergency responders 112, the local PSAP 116, and the one or more safety admin electronic devices 120 to communicate with each other in the virtual talk group 118 using the single communication channel 114.

In some examples, the emergency responders 112 in the virtual talk group 118 depends on the type of emergency event 110. For example, if the emergency event 110 is an active shooter, emergency responders 112 that are part of police, SWAT, and medical emergency teams should be connected to the single communication channel 114 in the virtual talk group 118 while emergency responders 112 that respond to chemical spills do not need to be connected to the single communication channel 114. Each of the emergency responders 112 can have their own separate communication lines in addition to the single communication channel 114. For example, emergency responder 112b and 112c may have a separate communication channel 124.

In an example, an emergency event 110 can occur. The emergency event 110 may be a school shooting or potential school shooting, a workplace shooting or potential workplace shooting, a bomb threat, fire, natural disaster, chemical spill or environmental hazard, riot or mass civil unrest, kidnapping or hostage situation, or some other to public safety threat. When the emergency event 110 is detected, the emergency event detection mechanism 104 communicates with the safety management platform 108 regarding the detection of the emergency event 110. The safety management platform 108 uses the disparate systems connection engine 106 to automatically connect the emergency responders 112 to the virtual talk group 118 and allow the emergency responders 112 to communicate with each other using the single communication channel 114. In addition, the disparate systems connection engine 106 automatically connects the local PSAP 116 to the virtual talk group 118 to allow the emergency responders 112 and a human operator at the local PSAP 116 to communicate with each other using the single communication channel 114. In some examples, the disparate systems connection engine 106 automatically connects the one or more safety admin electronic devices 120 to the virtual talk group 118 to allow the emergency responders 112, the human operator at the local PSAP 116, and the one or more safety admin electronic devices 120 to communicate with each other using the single communication channel 114. The emergency responders 112 include fire responders, police responders, public safety responders, special weapons and tactics (SWAT) responders, rescue responders, hazard materials and conditions responders, and other emergency responders that are needed to respond to the emergency event 110.

When the emergency event 110 is detected and emergency event detection mechanism 104 communicates with the safety management platform 108 regarding the detection of the emergency event 110, the safety management platform 108 can be configured to initiate or trigger an emergency event response that includes a preparation feature that integrates response measures to include access to known location data, registered administrator data, actions, responsibilities, etc., all of which are retrieved and distributed to the emergency responders 112 and the human operator at the local PSAP 116 and in some examples, the one or more safety admin electronic devices 120. The safety management platform 108 can also be configured for automated monitoring of various sensors and devices, automated lockdown and assignment of responsibilities, etc. Another feature of the safety management platform 108 may include a reunification and recovery feature that directs third parties to certain information sources and instructs them to perform various actions to further the process of recovery and finalization of the emergency event.

The emergency responders 112, the human operator at the PSAP 116, and the one or more safety admin electronic devices 120 can benefit from access to detailed information regarding the status and type of the emergency event 110. Also, sharing information between each of the emergency responders 112, the human operator at the PSAP 116, and the one or more safety admin electronic devices 120 helps to increase the chances of success and containing the emergency event 110. In addition, using the one or more safety admin electronic devices 120, victims, potential victims, and others at the site of the emergency event 110 can provide essential details about the emergency event 110 to the emergency responders 112 and the human operator at the local PSAP 116 as well as receive instructions from the emergency responders 112 and the human operator at the local PSAP 116 about how to deal with the emergency event 110.

It is to be understood that other embodiments and implementations may be utilized, and structural changes may be made without departing from the scope of the present disclosure. Substantial flexibility is provided by the system and method in that any suitable arrangements and configuration may be provided without departing from the teachings of the present disclosure. For purposes of illustrating certain example techniques to enable connecting disparate communication systems in response to an emergency event, the following foundational information may be viewed as a basis from which the present disclosure may be properly explained. A number of prominent technological trends are currently afoot (e.g., more computing devices, more communicating devices, more Internet traffic), and these trends are changing the way emergency responders communicate during an emergency event. Often, during an emergency event, a PSAP will receive a call or text about the emergency event and dispatch several different types of emergency responders to the emergency event. Typically, each of the emergency responders communicate using a communication system that is unique to each specific emergency responder.

A PSAP, sometimes called a public-safety access point, is a call center where emergency/non-emergency calls (like police, fire brigade, ambulance) initiated by any landline, mobile or Voice Over Internet Protocol (“VOIP”) are received. When a communication is sent to a PSAP, a highly trained professional human PSAP operator is expected to respond to the communication. However, PSAP operators are part of an industry under immense pressure because of understaffing and a host of other issues. PSAP centers are struggling with surging call and text volumes, complex compounded emergencies, outdated technologies, and insufficient support. Some complex compounded emergencies require a response from several different types of emergency responders. Because each of the emergency responders communicate using a communication system that is unique to each specific emergency responder, operators at the PSAPs need to coordinate the response and communication with each emergency responder. This adds to the stress the PSAP operators face every day and is another deterrent to employee retention. What is needed is a system, an apparatus, and a method to help enable connecting disparate communication systems in response to an emergency event.

A system, method, apparatus, means, etc. to enable connecting disparate communication systems in response to an emergency event can help resolve these issues (and others). In an example, a system and method can include a disparate systems connection engine (e.g., the disparate systems connection engine 106). The disparate systems connection engine can create a virtual talk group and use a single communication channel between multiple emergency responders and a local PSAP to allow the emergency responders and a human operator at the local PSAP to communicate with each other using the single communication channel.

The single communication channel can be automatically created in response to activation of an emergency event detection mechanism (e.g., the emergency event detection mechanism 104). In some examples, the emergency event detection mechanism is a user activated detection mechanism where a user that observes or is made aware of an emergency event can activate the emergency event detection mechanism. In other examples, the emergency event detection mechanism may be an IoT device and/or a computer model that uses one or more inputs to detect an emergency event. For example, the emergency event detection mechanism may be a security camera that is trained to recognized various firearms or weapons and when a firearm or weapon is recognized or detected, the emergency event detection mechanism is activated. In some examples, the emergency event detection mechanism can be used as a general emergency event detection mechanism (one mechanism for an active shooter, fire, chemical spill, etc.). In other examples, the emergency event detection mechanism can be used as a specific emergency event detection mechanism (an active shooter). In yet other examples, the emergency event detection mechanism can be used as multiple specific emergency event detection mechanisms (e.g., one mechanism for an active shooter, a second mechanism for a fire, a third mechanism for a chemical spill, etc.)

In an illustrative example, a specific emergency event is detected. Based on the type of the specific emergency event, a safety management platform determines two or more emergency responders needed to respond to the specific emergency event and the disparate systems connection engine can automatically create a virtual talk group and use a single communication channel to facilitate communications between the between the two or more emergency responders needed to respond to the specific emergency event. In addition, a local PSAP and one or more admin electronic devices can be identified, if any, and automatically added to the virtual talk group to allow the two or more emergency responders needed to respond to the specific emergency event, the local PSAP, and the identified one or more admin electronic devices to use the single communication channel to facilitate communications. In a specific example of a school shooting, the one or more admin electronic devices are associated with key administrative personal at the school where the shooting is occurring and the key administrative personal can communicate with first responders and the PSAP directly using the single communication channel.

Recent emergency events demonstrate that lives can be saved if the emergency response team has access to all the potentially necessary information needed to engage the emergency event upon arrival at the emergency event location. In some examples, the safety management platform and/or an emergency data engine can be configured to identify a response strategy plan and communicate data related to the emergency event to help ensure the emergency responders can respond to the emergency event properly and without any unnecessary delays. For example, the data may include floor plans of buildings where the emergency event is occurring, access codes to unlock and lock doors and other passages, contact information, live feeds of videos and other sensor data, special requirement information, a density map of mobile devices at the emergency location, sensor data received from the emergency location, and/or other data to help ensure the emergency responders can respond to the emergency event. The sensor data may include the detection of a firearm or weapon, an unknown facial recognition instance, an unknown voice recognition instance, an identified emergency sound (e.g., gunshot or explosion), an identified emergency temperature, an identified emergency air quality disturbance, and other information related to the emergency event. In some examples, the data may also include real time voice, video, audio, or images, of the emergency event and the area around the emergency event. In some examples, using the one or more safety admin electronic devices, instructions can be communicated to users of the one or more safety admin electronic devices to lock doors, identify certain students, keep the safety admin electronic device operating to listen for audio, provide video, and/or confirm questions as they are answered to affirm whether a perpetrator is present or certain safety measures have been performed.

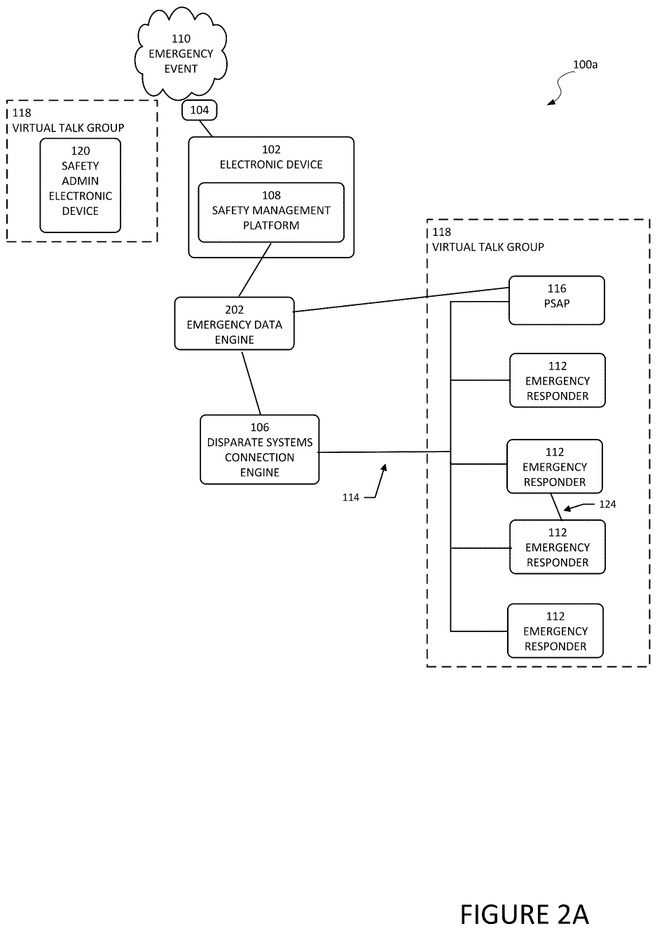

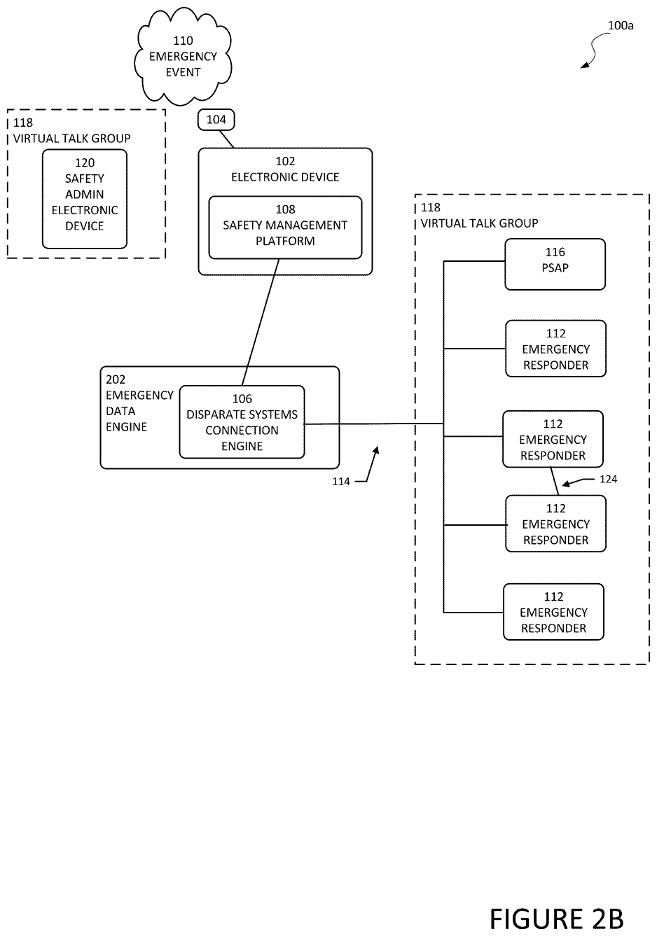

Turning to FIGS. 2A and 2B, FIGS. 2A and 2B are simplified block diagrams illustrating example details of a particular non-limiting system 100a to enable connecting disparate communication systems in response to an emergency event. The system 100a can include the emergency event detection mechanism 104, the safety management platform 108, the disparate systems connection engine 106, and an emergency data engine 202. In some examples, as illustrated in FIG. 2B, the emergency data engine 202 includes the disparate systems connection engine 106. The emergency event detection mechanism 104 and/or the safety management platform 108 can contribute to identifying the emergency event.

The emergency data engine 202 can be configured to identifying a response strategy plan, such as by sharing data, and determining which actions to take and when to perform such actions. In response to receiving a notification regarding the emergency event 110, the emergency data engine 202 can communicate with the disparate systems connection engine 106 to automatically create the single communication channel 114 to allow emergency responders 112 and the local PSAP 116 to communicate with each other using the single communication channel 114. In some examples, the emergency data engine 202 can establish a connection with the local PSAP 116 before the local PSAP 116 is added to the single communication channel 114. This allows the local PSAP 116 to get a head start on responding to the emergency event 110. In some examples, the emergency data engine 202 can be configured to identify and automatically add the one or more safety admin electronic devices 120 to the virtual talk group 118.

Using the single communication channel 114, data and resources related to the emergency event 110 can be shared with the emergency responders 112. For example, the emergency data engine 202 can communicate the data necessary to ensure the emergency responders 112 can respond to the emergency event 110 properly and without any unnecessary delays. Examples of the data that may be shared by the emergency data engine 202 include, but is not limited to, floor plans of buildings where the emergency event 110 is occurring, access codes to unlock and lock doors and other passages, contact information, live feeds of videos and other sensory equipment, special requirement information, and other information related to the emergency event 110.

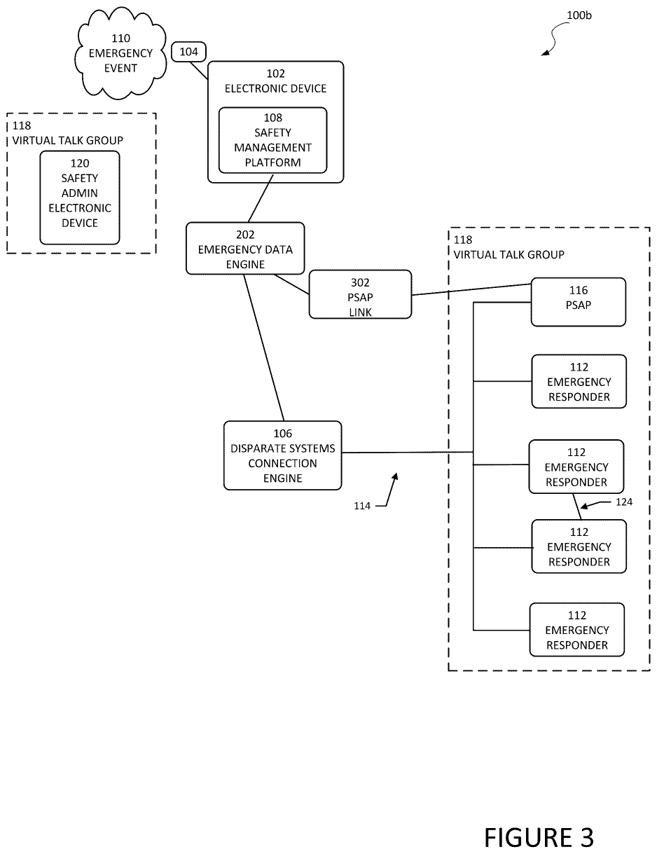

Turning to FIG. 3, FIG. 3 is a simplified block diagram illustrating example details of a particular non-limiting system 100b to enable connecting disparate communication systems in response to an emergency event. The system 100b can include the emergency event detection mechanism 104, the safety management platform 108, the disparate systems connection engine 106, the emergency data engine 202, and a PSAP link 302. The PSAP link 302 can be used to determine an appropriate local PSAP 116 to help respond to the emergency event 110. More specifically, the PSAP link 302 can be configured to identify the closest PSAP to the emergency event 110 and/or the PSAP with the resources to help with the response to the emergency event 110.

Turning to FIG. 4, FIG. 4 illustrates simplified block diagram non-limiting examples details of the emergency event detection mechanism 104. In an example, an emergency event detection mechanism 104a can include a mechanical or electric push button 402 where, when a user pushes down on the push button 402, a signal is sent to the safety management platform 108 (not shown) to communicate with the safety management platform 108 regarding the detection of the emergency event 110. In another example, an emergency event detection mechanism 104b can include a flip switch 404 where, when a user flips the flip switch 404 to one side, a signal is sent to the safety management platform 108 (not shown) to communicate with the safety management platform 108 regarding the detection of the emergency event 110. In yet another example, an emergency event detection mechanism 104c can include a rocker switch 406 where, when a user pushes down one side of the rocker switch 406, a signal is sent to the safety management platform 108 (not shown) to communicate with the safety management platform 108 regarding the detection of the emergency event 110.

In an example, an emergency event detection mechanism 104d can include a biometric authentication mechanism 408, where, when a user is biometrically authenticated by the biometric authentication mechanism 408, a signal is sent to the safety management platform 108 (not shown) to communicate with the safety management platform 108 regarding the detection of the emergency event 110. The biometric authentication can include fingerprint recognition, facial recognition, retinal recognition, vein recognition, or some other type of biometric authentication. In some examples, the biometric authentication mechanism 408 can be used in conjunction with the emergency event detection mechanism 104a, 104b, or 104c.

In another example, an emergency event detection mechanism 104e can include a keypad mechanism 410. The keypad mechanism 410 can include a plurality of keys 412 where when a user uses the plurality of keys 412 in the keypad mechanism 410 to enter a predetermined code or sequence of keypresses, a signal is sent to the safety management platform 108 (not shown) to communicate with the safety management platform 108 regarding the detection of the emergency event 110. The plurality of keys 412 can include number keys, alphanumeric keys, symbols or some other types of keys that can be used to enter a predetermined code or sequence of keypresses. In some examples, the keypad mechanism 410 can include a display 414 to display a digital representation of a specific key 412 that is pressed by the user when the user is entering the predetermined code or sequence of keypresses. In some examples, the biometric authentication mechanism 408 can be used in conjunction with the emergency event detection mechanism 104e.

In yet another example, an emergency event detection mechanism 104f may be part of a safety application 416 displayed on a display 418 of an electronic device 420. In some examples, the electronic device 420 is the safety admin electronic device 120. The electronic device 420 can be a smart phone, smart watch, tablet, computer, wearable, or some other electronic device that can include a display 418. The emergency event detection mechanism 104f can be a user selectable icon (e.g., a digital representation of a button or some other icon) a user can touch or press to cause a signal to be sent to the safety management platform 108 (not shown) to communicate with the safety management platform 108 regarding the detection of the emergency event 110.

Turning to FIG. 5, FIG. 5 illustrates simplified block diagram non-limiting examples details of the emergency event detection mechanism 104. As illustrated in FIG. 5, an emergency event detection mechanism 104g can include a plurality of mechanical or electric push buttons 402a-402c. Each of the plurality of push buttons 402a-402c can correspond to a specific type of emergency event. For example, push button 402a can correspond to an active shooter, push button 402b can correspond to a fire, and push button 402c can correspond to a riot or mass unrest.

When a user pushes down on the push button 402a, a signal is sent to the safety management platform 108 (not shown) to communicate with the safety management platform 108 regarding the detection of an active shooter emergency event 110. The safety management platform 108 communicates with the disparate systems connection engine 106 to automatically create the single communication channel 114 for each of the emergency responders 112 that are needed to respond to the active shooter emergency event 110. When a user pushes down on the push button 402b, a signal is sent to the safety management platform 108 (not shown) to communicate with the safety management platform 108 regarding the detection of a fire emergency event 110. The safety management platform 108 communicates with the disparate systems connection engine 106 to automatically create the single communication channel 144 for each of the emergency responders 112 that are needed to respond to the fire emergency event 110. When a user pushes down on the push button 402c, a signal is sent to the safety management platform 108 (not shown) to communicate with the safety management platform 108 regarding the detection of a riot or mass unrest emergency event 110. The safety management platform 108 communicates with the disparate systems connection engine 106 to automatically create the single communication channel 114 for each of the emergency responders 112 that are needed to respond to the riot or mass unrest emergency event 110. Note that the emergency responders 112 that are needed to respond to an active shooter will be different than the emergency responders 112 that are needed to respond to a fire and may be different than the emergency responders 112 that are need to respond to a riot or mass unrest. Also, instead of one or more of the push buttons 402a-402c, the emergency event detection mechanism 104 can include a plurality of flip switches 404, a plurality of rocker switches 406, or some other type of mechanism that can be used to send a signal to the safety management platform 108 when a specific type of emergency event 110 is detected.

In some examples, an emergency event detection mechanism 104h can include the keypad mechanism 410. The keypad mechanism 410 can include the plurality of keys 412 where a user uses the plurality of keys 412 in the keypad mechanism 410 to enter a predetermined code or sequence of keypresses associated with a specific emergency event. Note that the following examples are non-limiting illustrative examples because any specific emergency event can be assigned a unique predetermined code or unique sequence of keypresses. For example, a first predetermined code or sequence of keypresses can correspond to an active shooter, a second predetermined code or sequence of keypresses can correspond to a hazardous chemical spill or an environmental emergency, a third predetermined code or sequence of keypresses can correspond to a hostage situation, etc. In some examples, the keypad mechanism 410 can include the display 414 to display a digital representation of a specific key 412 that is pressed by the user when the user is entering the predetermined code or sequence of keypresses. In some examples, the display 414 may display a name or description of the specific emergency event associated with the predetermined code or sequence of keypresses.

When a user enters the first predetermined code or sequence of keypresses, a signal is sent to the safety management platform 108 (not shown) to communicate with the safety management platform 108 regarding the detection of an active shooter emergency event 110. The safety management platform 108 communicates with the disparate systems connection engine 106 to automatically create the single communication channel 114 for each of the emergency responders 112 that are needed to respond to the active shooter emergency event 110. When a user enters the second predetermined code or sequence of keypresses, a signal is sent to the safety management platform 108 (not shown) to communicate with the safety management platform 108 regarding the detection of a hazardous chemical spill or an environmental emergency event 110. The safety management platform 108 communicates with the disparate systems connection engine 106 to automatically create the single communication channel 144 for each of the emergency responders 112 that are needed to respond to the hazardous chemical spill or the environmental emergency event 110. When a user enters the third predetermined code or sequence of keypresses, a signal is sent to the safety management platform 108 (not shown) to communicate with the safety management platform 108 regarding a hostage situation emergency event 110. The safety management platform 108 communicates with the disparate systems connection engine 106 to automatically create the single communication channel 114 for each of the emergency responders 112 that are needed to respond to the hostage situation emergency event 110. Note that the emergency responders 112 that are needed to respond to an active shooter will be different than the emergency responders 112 that are needed to respond to a hazardous chemical spill or an environmental emergency and may be different than the emergency responders 112 that are need to respond to a hostage situation.

In some examples, an emergency event detection mechanism 104i may be part of a safety application 506 displayed on the display 418 of the electronic device 420. The emergency event detection mechanism 104f include a plurality of user selectable icons a user can touch or press where each user selectable icon is associated with a specific emergency event. Note that the following examples are non-limiting illustrative examples because any specific emergency event can be assigned a user selectable icon. For example, a first user selectable icon can correspond to an active shooter, a second user selectable icon can correspond to a fire, a third user selectable icon can correspond to a hazardous chemical spill or an environmental emergency, a fourth user selectable icon can correspond to a riot or mass civil unrest, a fifth user selectable icon can correspond to a hostage situation, etc.

When a user selects the first user selectable icon, a signal is sent to the safety management platform 108 (not shown) to communicate with the safety management platform 108 regarding the detection of an active shooter emergency event 110. The safety management platform 108 communicates with the disparate systems connection engine 106 to automatically create the single communication channel 114 for each of the emergency responders 112 that are needed to respond to the active shooter emergency event 110. When the user selects the second user selectable icon, a signal is sent to the safety management platform 108 (not shown) to communicate with the safety management platform 108 regarding the detection of a fire emergency event 110. The safety management platform 108 communicates with the disparate systems connection engine 106 to automatically create the single communication channel 144 for each of the emergency responders 112 that are needed to respond to the fire emergency event 110. When a user selects the third user selectable icon, a signal is sent to the safety management platform 108 (not shown) to communicate with the safety management platform 108 regarding the detection of a hazardous chemical spill or an environmental emergency event 110. The safety management platform 108 communicates with the disparate systems connection engine 106 to automatically create the single communication channel 144 for each of the emergency responders 112 that are needed to respond to the hazardous chemical spill or the environmental emergency event 110. When the user selects the fourth user selectable icon, a signal is sent to the safety management platform 108 (not shown) to communicate with the safety management platform 108 regarding the detection of a riot or mass unrest emergency event 110. The safety management platform 108 communicates with the disparate systems connection engine 106 to automatically create the single communication channel 114 for each of the emergency responders 112 that are needed to respond to the riot or mass unrest emergency event 110. When a user selects the fifth user selectable icon, a signal is sent to the safety management platform 108 (not shown) to communicate with the safety management platform 108 regarding a hostage situation emergency event 110. The safety management platform 108 communicates with the disparate systems connection engine 106 to automatically create the single communication channel 114 for each of the emergency responders 112 that are needed to respond to the hostage situation emergency event 110. Note that the emergency responders 112 that are needed to respond to an active shooter may be different than the emergency responders 112 that are needed to respond to a fire emergency, a hazardous chemical spill, an environmental emergency riot or mass unrest, and/or a hostage situation.

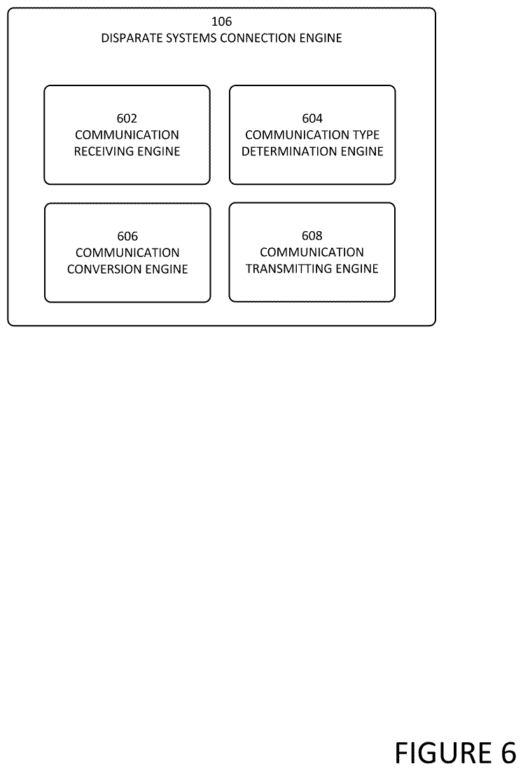

Turning to FIG. 6, FIG. 6 illustrates a simplified non-limiting block diagram of the disparate systems connection engine 106. As illustrated in FIG. 6, the disparate systems connection engine 106 can include a communication receiving engine 602, a communication type determination engine 604, a communication conversion engine 606, and a communication transmitting engine 608. The communication receiving engine 602 is configured to received communications from emergency responders 112, the PSAP 116, and the one or more safety admin electronic devices 120. The communication type determination engine 604 is configured to determine a type of communication system used by one or more destinations of a received communication. For example, the virtual talk group 118 can include the emergency responders 112a-112d, the PSAP 116, and one or more safety admin electronic devices 120. When a communication is received from the emergency responder 112a, the communication has a destination of the emergency responders 112b-112d, the PSAP 116, and one or more safety admin electronic devices 120. The communication type determination engine 604 can determine the type of communication system used by each of the emergency responders 112b-112d, the PSAP 116, and one or more safety admin electronic devices 120 that will receive the communication from the emergency responder 112a. The communication conversion engine 606 is configured to convert the received communication into a communication type that is compatible with the communication system used by a destination of the received communication. For example, the communication conversion engine 606 can convert the communication received from the emergency responder 112a to a communication type that is compatible with the emergency responder 112b, a communication type that is compatible with the emergency responder 112c, a communication type that is compatible with the emergency responder 112d, a communication type that is compatible with the PSAP 116, and a communication type that is compatible with the one or more safety admin electronic devices 120. The communication transmitting engine 608 is configured to send the converted communications to the emergency responders 112, the PSAP 116, and the one or more safety admin electronic devices 120.

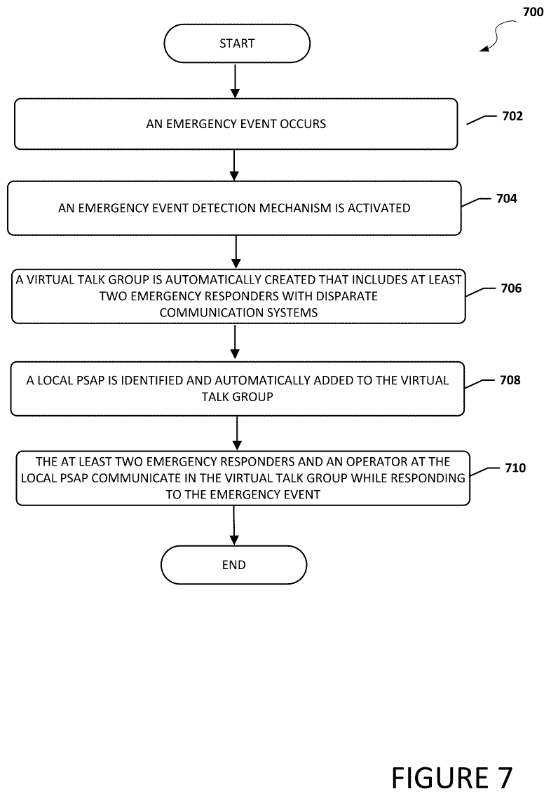

Turning to FIG. 7, FIG. 7 is example flowchart illustrating possible operations of a flow 700 that may be associated with potential operations to help enable connecting disparate communication systems in response to an emergency event, in accordance with an embodiment of the present disclosure. Specifically, in some examples, one or more operations of flow 700 may be performed by the emergency event detection mechanism 104, the safety management platform 108, the disparate systems connection engine 106, the emergency data engine 202, the PSAP link 302, the communication receiving engine 602, the communication type determination engine 604, the communication conversion engine 606, and/or the communication transmitting engine 608. At 702, an emergency event occurs. For example, the emergency event 110 can occur. At 704, an emergency event detection mechanism is activated. For example, the emergency event detection mechanism 104 may be activated. The emergency event detection mechanism 104 can be a user activated detection mechanism. For example, a user that observes or is made aware of an emergency event can activate the emergency event detection mechanism 104. In some examples, the emergency event detection mechanism 104 may be an IoT device and/or a computer model that uses one or more inputs to detect an emergency event. For example, the emergency event detection mechanism 104 may be a security camera that is trained to recognized various firearms or weapons, a fire hazard, riot or civil unrest, etc.

At 706, a virtual talk group is automatically created that includes at least two emergency responders with disparate communication systems. For example, the disparate systems connection engine 106 can automatically create the virtual talk group 118. The virtual talk group 118 can include the emergency responders 112a-112d where at least two of the emergency responders have disparate communication systems. At 708, a local PSAP is identified and automatically added to the virtual talk group. For example, the safety management platform 108, the emergency data engine 202, or the PSAP link 302 can identify the PSAP 116 as the local PSAP and the disparate systems connection engine 106 can automatically add the PSAP 116 to the virtual talk group 118. At 710, the at least two emergency responders and an operator at the local PSAP communicate in the virtual talk group while responding to the emergency event. For example, using the single communication channel 114, the emergency responders 112a-112d and an operator at the local PSAP 116 can communicate in the virtual talk group 118 while responding to the emergency event 110.

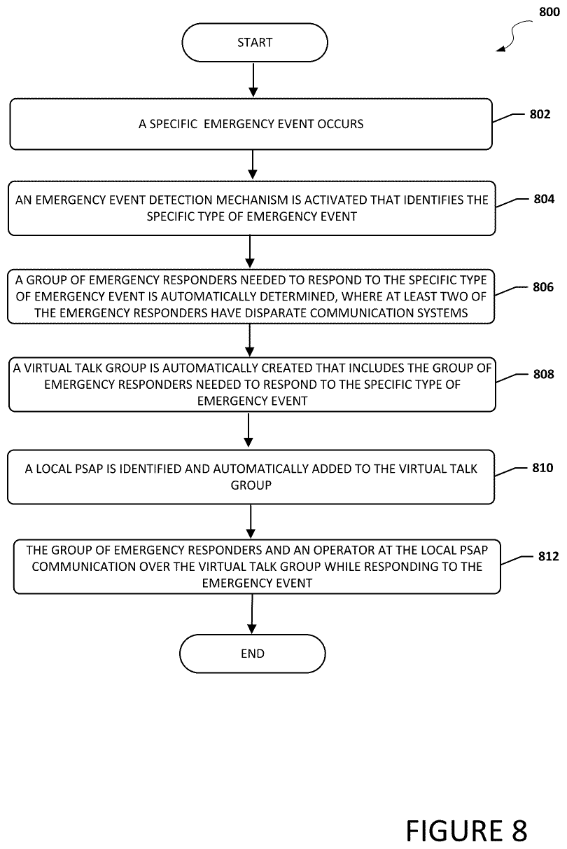

Turning to FIG. 8, FIG. 8 is example flowchart illustrating possible operations of a flow 800 that may be associated with potential operations to help enable connecting disparate communication systems in response to an emergency event, in accordance with an embodiment of the present disclosure. Specifically, in some examples, one or more operations of flow 800 may be performed by the emergency event detection mechanism 104, the safety management platform 108, the disparate systems connection engine 106, the emergency data engine 202, the PSAP link 302, the communication receiving engine 602, the communication type determination engine 604, the communication conversion engine 606, and/or the communication transmitting engine 608. At 802, a specific emergency event occurs. For example, the emergency event 110 can occur.

At 804, an emergency event detection mechanism is activated that identifies the specific type of emergency event. For example, a specific push button 402 (e.g., 402a, 402b, or 402c) may be activated on the emergency event detection mechanism 104g to identify the specific type of emergency event 110. In another example, the plurality of keys 412 in the keypad mechanism 410 of the emergency event detection mechanism 104h can be used to enter a predetermined code or sequence of keypresses associated with a specific emergency event 110. In yet another example, the safety application 506 displayed on a display 418 of an electronic device 420 may be used where a user selects a user selectable icon from the plurality of user selectable icons in the emergency event detection mechanism 104i to identify the specific type of emergency event 110. In other examples, a computer model trained to detect the specific type of emergency event identified the occurrence of the specific type of emergency event.

At 806, a group of emergency responders needed to respond to the specific type of emergency event is automatically determined, where at least two of the emergency responders have disparate communication systems. For example, based on the specific emergency event 110, a computer model, the safety management platform 108, the disparate systems connection engine 106, or the emergency data engine 202 can determine the emergency responders 112 needed to respond to the emergency event 110.

At 808, a virtual talk group is automatically created that includes the group of emergency responders needed to respond to the specific type of emergency event. For example, the disparate systems connection engine 106 can automatically create the virtual talk group 118. The virtual talk group 118 can include the emergency responders 112a-112d where at least two of the emergency responders have disparate communication systems. At 810, a local PSAP is identified and automatically added to the virtual talk group. For example, the safety management platform 108, the emergency data engine 202, or the PSAP link 302 can identify the PSAP 116 as the local PSAP and the disparate systems connection engine 106 can automatically add the PSAP 116 to the virtual talk group 118. At 812, the group of emergency responders and an operator at the local PSAP communicate in the virtual talk group while responding to the emergency event. For example, using the single communication channel 114, the emergency responders 112a-112d and an operator at the local PSAP 116 can communicate in the virtual talk group 118 while responding to the emergency event 110.

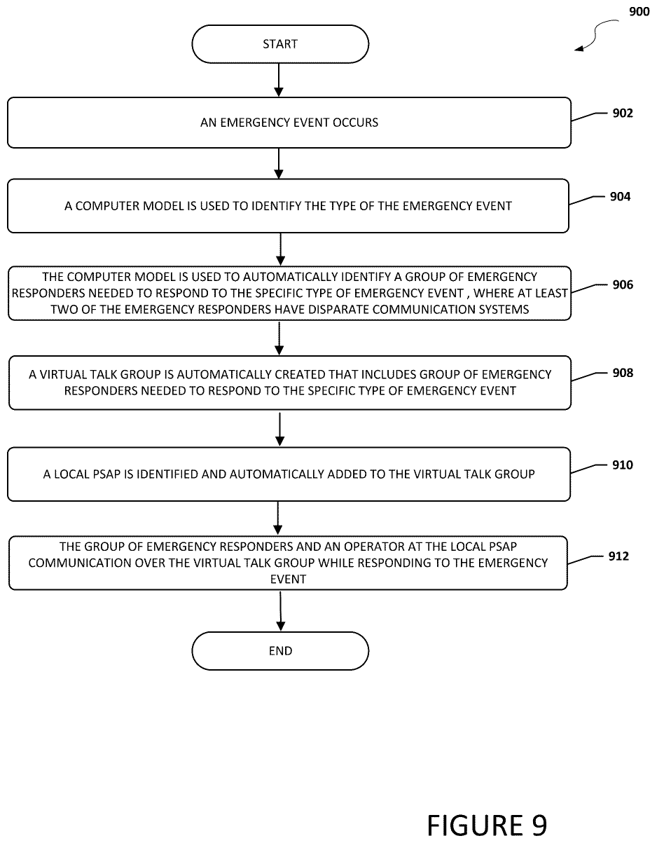

Turning to FIG. 9, FIG. 9 is example flowchart illustrating possible operations of a flow 900 that may be associated with potential operations to help enable connecting disparate communication systems in response to an emergency event, in accordance with an embodiment of the present disclosure. Specifically, in some examples, one or more operations of flow 900 may be performed by the emergency event detection mechanism 104, the safety management platform 108, the disparate systems connection engine 106, the emergency data engine 202, the PSAP link 302, the communication receiving engine 602, the communication type determination engine 604, the communication conversion engine 606, and/or the communication transmitting engine 608. At 902, an emergency event occurs. For example, the emergency event 110 can occur. At 904, a computer model is used to identify the type of the emergency event. For example, the emergency event detection mechanism 104 may be an IoT device and/or a computer model that uses one or more inputs to detect an emergency event. More specifically, the emergency event detection mechanism 104 may be a security camera that is trained to recognized various firearms or weapons, a fire hazard, a riot or civil unrest, etc.

At 906, the computer model is used to automatically identify a group of emergency responders needed to respond to the specific type of emergency event, where at least two of the emergency responders have disparate communication systems. For example, based on the specific emergency event 110, a computer model in the safety management platform 108, the disparate systems connection engine 106, or the emergency data engine 202 can automatically determine the emergency responders 112 needed to respond to the emergency event 110. At 908, a virtual talk group is automatically created that includes the group of emergency responders needed to respond to the specific type of emergency event. For example, the disparate systems connection engine 106 can automatically create the virtual talk group 118. The virtual talk group 118 can include the emergency responders 112a-112d where at least two of the emergency responders have disparate communication systems. At 910, a local PSAP is identified and automatically added to the virtual talk group. For example, the safety management platform 108, the emergency data engine 202, or the PSAP link 302 can identify the PSAP 116 as the local PSAP and the disparate systems connection engine 106 can automatically add the PSAP 116 to the virtual talk group 118. At 912, the group of emergency responders and an operator at the local PSAP communicate in the virtual talk group while responding to the emergency event. For example, using the single communication channel 114, the emergency responders 112a-112d and an operator at the local PSAP 116 can communicate in the virtual talk group 118 while responding to the emergency event 110.

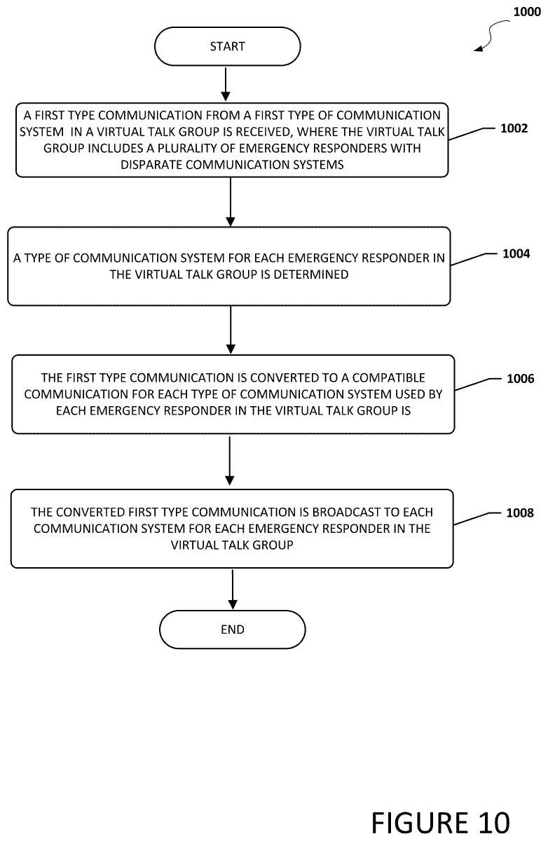

Turning to FIG. 10, FIG. 10 is example flowchart illustrating possible operations of a flow 1000 that may be associated with potential operations to help enable connecting disparate communication systems in response to an emergency event, in accordance with an embodiment of the present disclosure. Specifically, in some examples, one or more operations of flow 1000 may be performed by the safety management platform 108, the disparate systems connection engine 106, the emergency data engine 202, the PSAP link 302, the communication receiving engine 602, the communication type determination engine 604, the communication conversion engine 606, and/or the communication transmitting engine 608. At 1002, a first type communication from a first type of communication system in a virtual talk group is received, where the virtual talk group includes a plurality of emergency responders with disparate communication systems. For example, the virtual talk group 118 can include first responders 112a-112d where a plurality of the first responders 112a-112d each have disparate communication systems and a communication can be sent from the emergency responder 112a and received by the communication receiving engine 602 in the disparate systems connection engine 106.

At 1004, a type of communication system for each emergency responder in the virtual talk group is determined. For example, the communication type determination engine 604 in the disparate systems connection engine 106 can determine the type of communication system used by each of the first responders 112a-112d in the virtual talk group 118. At 1106, the first type communication is converted to a compatible communication for each type of communication system used by each emergency responder in the virtual talk group. For example, the communication conversion engine 606 in the disparate systems connection engine 106 can convert the first type communication to a compatible type of communication for each of the first responders 112a-112d in the virtual talk group 118. At 1008, the converted first type communication is broadcast to each communication system for each emergency responder in the virtual talk group. For example, the communication transmitting engine 608 in the disparate systems connection engine 106 can broadcast, send, transmit, etc. the converted first type of communication to each of the first responders 112a-112d in the virtual talk group 118.

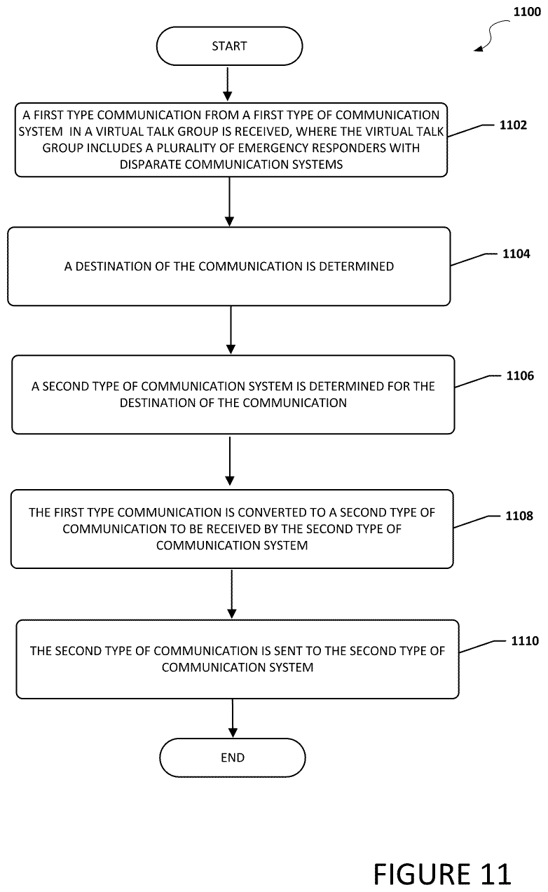

Turning to FIG. 11, FIG. 11 is example flowchart illustrating possible operations of a flow 1100 that may be associated with potential operations to help enable connecting disparate communication systems in response to an emergency event, in accordance with an embodiment of the present disclosure. Specifically, in some examples, one or more operations of flow 1100 may be performed by the safety management platform 108, the disparate systems connection engine 106, the emergency data engine 202, the PSAP link 302, the communication receiving engine 602, the communication type determination engine 604, the communication conversion engine 606, and/or the communication transmitting engine 608. At 1102, a first type communication from a first type of communication system in a virtual talk group is received, where the virtual talk group includes a plurality of emergency responders with disparate communication systems. For example, the virtual talk group 118 can include emergency responders 112a and 112b where the emergency responders 112a and 112b each have disparate communication systems and a communication can be sent from the emergency responder 112a and received by the communication receiving engine 602 in the disparate systems connection engine 106.

At 1104, a destination for the communication is determined. For example, the disparate systems connection engine 106 can determine a destination of the first type of communication. At 1106, a second type of communication system is determined for the destination of the communication. For example, the communication type determination engine 604 in the disparate systems connection engine 106 can determine the type of communication system used by the emergency responder 112b (the destination of the communication). At 1108, the first type communication is converted to a second type of communication to be received by the second type of communication system. For example, the communication conversion engine 606 in the disparate systems connection engine 106 can convert the first type communication to a compatible type of communication for the second type of communication system used by the emergency responder 112b in the virtual talk group 118. At 1010, the second type of communication is sent to the second type of communication system. For example, the communication transmitting engine 608 in the disparate systems connection engine 106 can send, transmit, etc. the second type of communication to the emergency responder 112b in the virtual talk group 118.

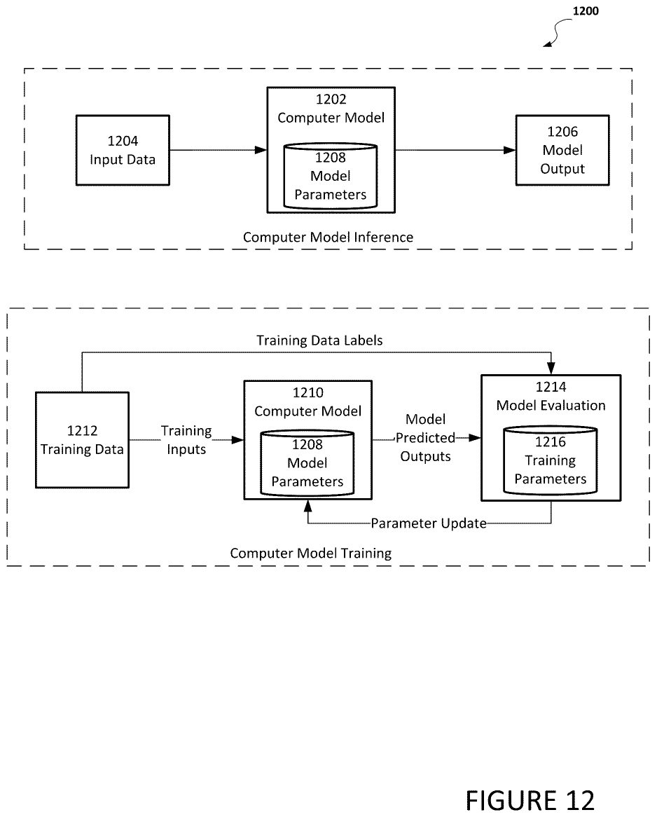

Turning to FIG. 12, FIG. 12 illustrates example computer model inference and computer model training 1200. Computer model inference refers to the application of a computer model 1202 to a set of input data 1204 to generate an output or model output 1206. The computer model 1202 determines the model output 1206 based on parameters of the model, also referred to as model parameters 1208. The parameters of the model may be determined based on a training process that finds an optimization of the model parameters 1208, typically using training data and desired outputs of the model for the respective training data as discussed below. The output (e.g., the detection of an emergency event, the type of emergency responders needed to respond to the emergency event, etc.) of the computer model 1202 may be referred to as an “inference” because it is a predictive value based on the input data 1204 and based on previous example data used in the model training.

The input data 1204 and the model output 1206 vary according to the particular use case. For example, to detect an emergency event, the input data 1204 may be data from one or more IoT devices and the output or “inference” may be a score or some other indication of the likelihood the IoT data is indicative of an emergency event or a potential emergency event. To determine the type of emergency responders needed to respond to the emergency event, the input data 1204 may be data that indicates the type of emergency event and the output or “inference” may be the type of emergency responders needed to respond to the same or a similar emergency event. In an illustrative example, for computer vision and image analysis, the input data 1204 may be an image having a particular resolution, such as 75×75 pixels, or a point cloud describing a volume. In other applications, the input data 1204 may include a vector, such as a sparse vector, representing information about an object. For example, in recommendation systems, such a vector may represent user-object interactions, such that the sparse vector indicates individual items positively rated by a user. In addition, the input data 1204 may be a processed version of another type of input object, for example representing various features of the input object or representing preprocessing of the input object before input of the object to the computer model 1202. As one example, a 1024×1024 resolution image may be processed and subdivided into individual image portions of 64×64, which are the input data 1204 processed by the computer model 1202. As another example, the input object, such as a sparse vector discussed above, may be processed to determine an embedding or another compact representation of the input object that may be used to represent the object as the input data 1204 in the computer model 1202. Such additional processing for input objects may themselves be learned representations of data, such that another computer model processes the input objects to generate an output that is used as the input data 1204 for the computer model 1202. Although not further discussed here, such further computer models may be independently or jointly trained with the computer model 1202. As noted above, the model output 1206 may depend on the particular application of the computer model 1202, for example, using data from IoT devices to help detect an emergency event.

The computer model 1202 includes various model parameters 1208, as noted above, that describe the characteristics and functions that generate the model output 1206 from the input data 1204. In particular, the model parameters 1208 may include a model structure, model weights, and a model execution environment. The model structure may include, for example, the particular type of computer model 1202 and its structure and organization. For example, the model structure may designate a neural network, which may be comprised of multiple layers, and the model parameters 1208 may describe individual types of layers included in the neural network and the connections between layers (e.g., the output of which layers constitute inputs to which other layers). Such networks may include, for example, feature extraction layers, convolutional layers, pooling/dimensional reduction layers, activation layers, output/predictive layers, and so forth. While in some instances the model structure may be determined by a designer of the computer model, in other examples, the model structure itself may be learned via a training process and may thus form certain “model parameters” of the model.

The model weights may represent the values with which the computer model 1202 processes the input data 1204 to the model output 1206. Each portion or layer of the computer model 1202 may have such weights. For example, weights may be used to determine values for processing inputs to determine outputs at a particular portion of a model. Stated another way, for example, model weights may describe how to combine or manipulate values of the input data 1204 or thresholds for determining activations as output for a model. As one example, a convolutional layer typically includes a set of convolutional “weights,” also termed a convolutional kernel, to be applied to a set of inputs to that layer. These are subsequently combined, typically along with a “bias” parameter, and weights for other transformations to generate an output for the convolutional layer.

The model execution parameters represent parameters describing the execution conditions for the model. In particular, aspects of the model may be implemented on various types of hardware or circuitry for executing the computer model 1202. For example, portions of the model may be implemented in various types of circuitry, such as general-purpose circuity (e.g., a general CPU), circuity specialized for certain functions (e.g., a GPU or programmable Multiply-and-Accumulate circuit) or circuitry specially designed for the particular computer model application. In some configurations, different portions of the computer model 1202 may be implemented on different types of circuitries. As discussed below, training of the model may include optimizing the types of hardware used for certain aspects of the computer model 1202 (e.g., co-trained), or may be determined after other parameters for the computer model 1202 are determined without regard to configuration executing the model. In another example, the execution parameters may also determine or limit the types of processes or functions available at different portions of the model, such as value ranges available at certain points in the processes, operations available for performing a task, and so forth.

Computer model training may thus be used to determine or “train” the values of the model parameters 1208 for the computer model 1210. During training, the model parameters 1208 are optimized to “learn” values of the model parameters (such as individual weights, activation values, model execution environment, etc.), that improve the model parameters 1208 based on an optimization function that seeks to improve a cost function (also sometimes termed a loss function). Before training, the computer model 1210 has model parameters 1208 that have initial values that may be selected in various ways, such as by a randomized initialization, initial values selected based on other or similar computer models, or by other means. During training, the model parameters are modified based on the optimization function to improve the cost/loss function relative to the prior model parameters.

In many applications, training data 1212 includes a data set to be used for training the computer model 1210. The data set varies according to the particular application and purpose of the computer model 1210. In supervised learning tasks, the training data 1212 typically includes a set of training data labels that describe the training data 1212 and the desired output of the model relative to the training data 1212. For example, for an emergency event or a potential emergency event task recognition task, the training data 1212 may include IoT data collected during an emergency event and labeled with the classification of the emergency event as well as the emergency responders dispatched to the emergency event. For this task, the training data 1212 may include IoT training data related to the emergency event and the type of emergency responders dispatched to the emergency event, such that the computer model 1210 is intended to learn to also label the same type of IoT data as being related to an emergency event and what type of emergency responders should be dispatched to the emergency event.

To train the computer model 1210, a training module (not shown) applies the training inputs to the computer model 1210 to determine the outputs predicted by the model for the given training inputs. The training module, though not shown, is a computing module used for performing the training of the computer model 1210 by executing the computer model 1210 according to its inputs and outputs given the model's parameters and modifying the model parameters based on the results. The training module may apply the actual execution environment of the computer model 1210, or may simulate the results of the execution environment, for example to estimate the performance, runtime, memory, or circuit area (e.g., if specialized hardware is used) of the computer model 1210. The training module, along with the training data 1212 and model evaluation, may be instantiated in software and/or hardware by one or more processing devices. In various examples, the training process may also be performed by multiple computing systems in conjunction with one another, such as distributed/cloud computing systems. In some examples the training of the computer module 1210 may be different if the computer model 1210 is a large language model (LLM) used for automated message responses as compared to being used to detect an emergency event and/or determine the type of emergency responders needed to respond to the emergency event. A LLM is used for language-based tasks, whereas the general computer model can be used for a variety of other tasks, including to detect an emergency event and/or determine the type of emergency responders needed to respond to the emergency event.

After processing the training inputs according to the current model parameters for the computer model 1210, the model's predicted outputs are evaluated and the computer model 1210 is evaluated with respect to the cost function and optimized using an optimization function of the training model. Depending on the optimization function, particular training process and training parameters 1216 after the model evaluation are updated to improve the optimization function of the computer model 1210. In supervised training (i.e., training data labels are available), the cost function may evaluate the model's predicted outputs relative to the training data labels and to evaluate the relative cost or loss of the prediction relative to the “known” labels for the data. This provides a measure of the frequency of correct predictions by the computer model 1210 and may be measured in various ways, such as the precision (frequency of false positives) and recall (frequency of false negatives). The cost function in some circumstances may also evaluate other characteristics of the model, for example the model complexity, processing speed, memory requirements, physical circuit characteristics (e.g., power requirements, circuit throughput) and other characteristics of the computer model 1210 structure and execution environment (e.g., to evaluate or modify these model parameters).

After determining results of the cost function, the optimization function determines a modification of the model parameters to improve the cost function for the training data 1212. Many such optimization functions are known to one skilled on the art. Many such approaches differentiate the cost function with respect to the parameters of the model and determine modifications to the model parameters that thus improves the cost function. The parameters for the optimization function, including algorithms for modifying the model parameters are the training parameters 1216 for the optimization function. For example, the optimization algorithm may use gradient descent (or its variants), momentum-based optimization, or other optimization approaches used in the art and as appropriate for the particular use of the model. The optimization algorithm thus determines the parameter updates to the model parameters. In some implementations, the training data 1212 is batched and the parameter updates are iteratively applied to batches of the training data 1212. For example, the model parameters may be initialized, then applied to a first batch of data to determine a first modification to the model parameters. The second batch of data may then be evaluated with the modified model parameters to determine a second modification to the model parameters, and so forth, until a stopping point, typically based on either the amount of training data 1212 available or the incremental improvements in model parameters are below a threshold (e.g., additional training data 1212 no longer continues to improve the model parameters). Additional training parameters 1216 may describe the batch size for the training data 1212, a portion of training data 1212 to use as validation data, the step size of parameter updates, a learning rate of the model, and so forth. Additional techniques may also be used to determine global optimums or address nondifferentiable model parameter spaces.

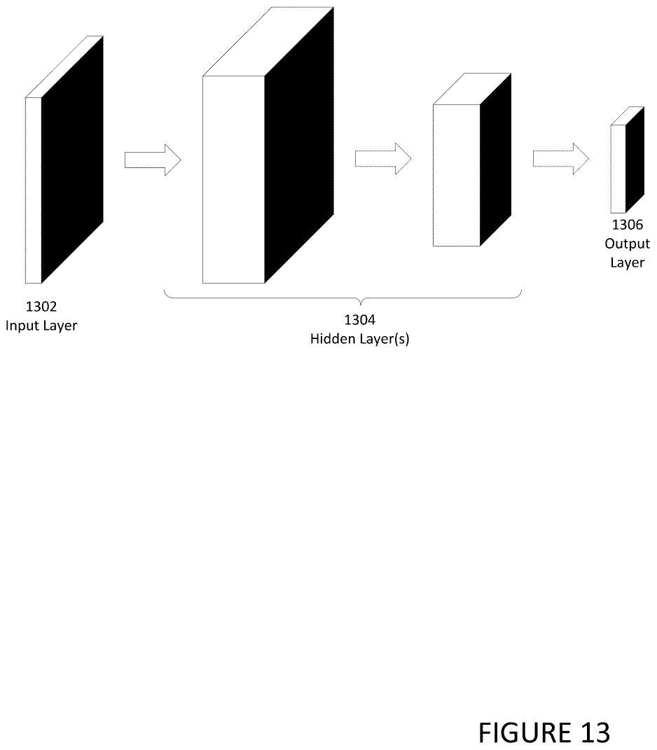

Turning to FIG. 13, FIG. 13 illustrates an example neural network architecture. In general, a neural network includes an input layer 1302, one or more hidden layers 1304, and an output layer 1306. The values for data in each layer of the network is generally determined based on one or more prior layers of the network. Each layer of a network generates a set of values, termed “activations” that represent the output values of that layer of a network and may be the input to the next layer of the network. For the input layer 1302, the activations are typically the values of the input data, although the input layer 1302 may represent input data as modified through one or more transformations to generate representations of the input data. For example, in recommendation systems, interactions between users and objects may be represented as a sparse matrix. Individual users or objects may then be represented as an input layer 1302 as a transformation of the data in the sparse matrix relevant to that user or object. The neural network may also receive the output of another computer model (or several), as its input layer 1302, such that the input layer 1302 of the neural network shown in FIG. 13 is the output of another computer model. Accordingly, each layer may receive a set of inputs, also termed “input activations,” representing activations of one or more prior layers of the network and generate a set of outputs, also termed “output activations” representing the activation of that layer of the network. Stated another way, one layer's output activations become the input activations of another layer of the network, except for the final output layer of 1306 of the network.

Each layer of the neural network typically represents its output activations (i.e., also termed its outputs) in a matrix, which may be 1, 2, 3, or n-dimensional according to the particular structure of the network. As shown in FIG. 13, the dimensionality of each layer may differ according to the design of each layer. The dimensionality of the output layer 1306 depends on the characteristics of the prediction made by the model. For example, a computer model for multi-object classification may generate an output layer 1306 having a one-dimensional array in which each position in the array represents the likelihood of a different classification for the input layer 1302. In another example for classification of portions of an image, the input layer 1302 may be an image having a resolution, such as 512×512, and the output layer may be a 512×512×n matrix in which the output layer 1306 provides n classification predictions for each of the input pixels, such that the corresponding position of each pixel in the input layer 1302 in the output layer 1306 is an n-dimensional array corresponding to the classification predictions for that pixel.

The hidden layers 1304 provide output activations that variously characterize the input layer 1302 in various ways that assist in effectively generating the output layer 1306. The hidden layers thus may be considered to provide additional features or characteristics of the input layer 1302. Though two hidden layers are shown in FIG. 13, in practice any number of hidden layers may be provided in various neural network structures.

Each layer generally determines the output activation values of positions in its activation matrix based on the output activations of one or more previous layers of the neural network (which may be considered input activations to the layer being evaluated). Each layer applies a function to the input activations to generate its activations. Such layers may include fully-connected layers (e.g., every input is connected to every output of a layer), convolutional layers, deconvolutional layers, pooling layers, and recurrent layers. Various types of functions may be applied by a layer, including linear combinations, convolutional kernels, activation functions, pooling, and so forth. The parameters of a layer's function are used to determine output activations for a layer from the layer's activation inputs and are typically modified during the model training process. The parameters describing the contribution of a particular portion of a prior layer is typically termed a weight. For example, in some layers, the function is a multiplication of each input with a respective weight to determine the activations for that layer. For a neural network, the parameters for the model as a whole thus may include the parameters for each of the individual layers and in large-scale networks can include hundreds of thousands, millions, or more of different parameters.

As one example for training a neural network, the cost function is evaluated at the output layer 1306. To determine modifications of the parameters for each layer, the parameters of each prior layer may be evaluated to determine respective modifications. In one example, the cost function (or “error”) is backpropagated such that the parameters are evaluated by the optimization algorithm for each layer in sequence, until the input layer 1302 is reached.

In the description, various aspects of the illustrative implementations are described using terms commonly employed by those skilled in the art to convey the substance of their work to others skilled in the art. However, it will be apparent to those skilled in the art that the embodiments disclosed herein may be practiced with only some of the described aspects. For purposes of explanation, specific numbers, materials, and configurations are set forth in order to provide a thorough understanding of the illustrative implementations. However, it will be apparent to one skilled in the art that the embodiments disclosed herein may be practiced without the specific details. In other instances, well-known features are omitted or simplified in order not to obscure the illustrative implementations.

In the detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). Reference to “one embodiment” or “an embodiment” in the present disclosure means that a particular feature, structure, or characteristic described in connection with the embodiment is included in at least one embodiment. The appearances of the phrase “in one embodiment” or “in an embodiment” are not necessarily all referring to the same embodiment. Reference to “one example” or “an example” in the present disclosure means that a particular feature, structure, or characteristic described in connection with the embodiment is included in at least one example or embodiment. The appearances of the phrase “in one example” or “in an example” are not necessarily all referring to the same examples or embodiments. The terms “substantially,” “close,” “approximately,” “near,” and “about,” generally refer to being within +/−20% of a target value based on the context of a particular value as described herein or as known in the art.

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur. Substantial flexibility is provided by the system, apparatus, and a method to enable connecting disparate communication systems in response to an emergency event in that any suitable arrangements, chronologies, configurations, and timing mechanisms may be provided without departing from the teachings of the present disclosure.

Note that embodiments of the emergency event detection mechanism 104, the safety management platform 108, the disparate systems connection engine 106, the emergency data engine 202, the PSAP link 302, the communication receiving engine 602, the communication type determination engine 604, the communication conversion engine 606, and/or the communication transmitting engine 608, may include one or more distinct interfaces, represented by any suitable network interfaces to facilitate communication via the various networks (including both internal and external networks) described herein. Such network interfaces may be inclusive of multiple wired and/or wireless interfaces (e.g., Wi-Fi, WiMax, 3G, 4G, 5G+, white space, 802.11x, satellite, Bluetooth, LTE, GSM/HSPA, CDMA/EVDO, DSRC, CAN, GPS, etc.). Other interfaces, may include physical ports (e.g., Ethernet, USB, HDMI, etc.), interfaces for wired and wireless internal subsystems, and the like. Similarly, each of the emergency event detection mechanism 104, the safety management platform 108, the disparate systems connection engine 106, the emergency data engine 202, the PSAP link 302, the communication receiving engine 602, the communication type determination engine 604, the communication conversion engine 606, and/or the communication transmitting engine 608 can also include suitable interfaces for receiving, transmitting, and/or otherwise communicating data or information in a network environment.

The emergency event detection mechanism 104, the safety management platform 108, the disparate systems connection engine 106, the emergency data engine 202, the PSAP link 302, the communication receiving engine 602, the communication type determination engine 604, the communication conversion engine 606, and/or the communication transmitting engine 608 and other associated or integrated components can include one or more memory elements for storing information to be used in achieving operations associated with connecting disparate communication systems in response to an emergency event, as outlined herein. These devices may further keep information in any suitable memory element (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. The information being tracked, sent, received, or stored in the system 100 could be provided in any database, register, table, cache, queue, control list, or storage structure, based on particular needs and implementations, all of which could be referenced in any suitable timeframe. Any of the memory or storage options discussed herein should be construed as being encompassed within the broad term ‘memory element’ as used herein in this Specification.

In example embodiments, the operations for enabling the connection of disparate communication systems in response to an emergency event, outlined herein, may be implemented by logic encoded in one or more tangible media, which may be inclusive of non-transitory media (e.g., embedded logic provided in an ASIC, digital signal processor (DSP) instructions, software potentially inclusive of object code and source code to be executed by a processor or other similar machine, etc.). In some of these instances, one or more memory elements can store data used for the operations described herein. This includes the memory elements being able to store software, logic, code, or processor instructions that are executed to carry out the connecting of disparate communication systems in response to an emergency event described in this Specification. Regarding a physical implementation of the emergency event detection mechanism 104, the safety management platform 108, the disparate systems connection engine 106, the emergency data engine 202, the PSAP link 302, the communication receiving engine 602, the communication type determination engine 604, the communication conversion engine 606, and/or the communication transmitting engine 608 and their associated components, any suitable permutation may be applied based on particular needs and requirements.

Note that with the examples provided herein, interaction may be described in terms of one, two, three, or more elements. However, this has been done for purposes of clarity and example only. In certain cases, it may be easier to describe one or more of the functionalities by only referencing a limited number of elements. It should be appreciated that the system, apparatus, and a method to enable connecting disparate communication systems in response to an emergency event and their teachings are readily scalable and can accommodate a large number of components, as well as more complicated/sophisticated arrangements and configurations. Accordingly, the examples provided should not limit the scope or inhibit the broad teachings of the system, apparatus, and method to enable obtaining additional information related to connecting disparate communication systems in response to an emergency event and as potentially applied to a myriad of other architectures.

It is also important to note that the operations in the preceding flow diagrams (i.e., FIGS. 7-11) illustrate only some of the possible correlating scenarios and patterns that may be executed, some of these operations may be deleted or removed where appropriate, or these operations may be modified or changed considerably without departing from the scope of the present disclosure. In addition, the timing of these operations may be altered considerably. The preceding operational flows have been offered for purposes of example and discussion. Substantial flexibility is provided in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although the system and method have been illustrated with reference to particular elements and operations, these elements and operations may be replaced by any suitable architecture, protocols, and/or processes that achieve the intended functionality of the system and method.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
identifying an emergency event is occurring;
determining two or more emergency responders needed to respond to the emergency event, wherein the two or more emergency responders use disparate communication systems; and
automatically creating a virtual talk group with a single communication channel to facilitate communications between the two or more emergency responders that use disparate communication systems.

2. The method of claim 1, wherein a computer model is used to identify that the emergency event is occurring.

3. The method of claim 2, wherein the computer model is used to determine the two or more emergency responders needed to respond to the emergency event.

4. The method of claim 1, further comprising:
adding a public safety answering point (PSAP) to the virtual talk group with the single communication channel.

5. The method of claim 1, further comprising:
adding one or more safety admin electronic devices to the virtual talk group with the single communication channel, wherein users of the one or more safety admin electronic devices are experiencing the emergency event.

6. The method of claim 5, wherein the one or more safety admin electronic devices are cell phones.

7. The method of claim 1, further comprising:
using the single communication channel to communicate data related to the emergency event to the two or more emergency responders.

8. A system, comprising:
memory;
at least one processor;
a safety management platform configured to:
determine an emergency event is occurring; and
determine two or more emergency responders needed to respond to the emergency event, wherein the two or more emergency responders use disparate communication systems; and
a disparate systems connection engine configured to:
in response to the determination that an emergency event is occurring, automatically create a virtual talk group with a single communication channel to facilitate communications between the two or more emergency responders that use disparate communication systems.

9. The system of claim 8, wherein the safety management platform is further configured to:
determine a type of emergency event that is occurring wherein a type of the two or more emergency responders needed to respond to the emergency event is based on the determined type of the emergency event that is occurring.

10. The system of claim 8, wherein the disparate systems connection engine is further configured to:
add a public safety answering point (PSAP) to the virtual talk group with the single communication channel.

11. The system of claim 8, wherein the disparate systems connection engine is further configured to:
add one or more safety admin electronic devices to the virtual talk group with the single communication channel, wherein users of the one or more safety admin electronic devices are experiencing the emergency event.

12. The system of claim 11, wherein the one or more safety admin electronic devices are cell phones.

13. The system of claim 8, wherein the single communication channel is used to communicate data related to the emergency event to the two or more emergency responders.

14. The system of claim 8, wherein safety management platform uses a signal from an emergency event detection mechanism to determine an emergency event is occurring.

15. A method, comprising:
in response to receiving a communication from an emergency event detection mechanism, determining a type of emergency event and two or more types of emergency responders needed to respond to the emergency event; and
automatically creating a virtual talk group with a single communication channel to facilitate communications between the two or more types of emergency responders that use disparate communication systems.

16. The method of claim 15, wherein a computer model is used to identify the type of emergency event and the type of emergency responders needed to respond to the emergency event.

17. The method of claim 15, further comprising:
adding a public safety answering point (PSAP) to the virtual talk group with the single communication channel.

18. The method of claim 15, further comprising:
adding one or more safety admin electronic devices to the virtual talk group with the single communication channel, wherein users of the one or more safety admin electronic devices are experiencing the emergency event.

19. The method of claim 18, wherein the one or more safety admin electronic devices are cell phones.

20. The method of claim 15, further comprising:
using the single communication channel to communicate data related to the emergency event to the two or more types of emergency responders.
